(19) United States
(12) Patent Application Publication
(10) Pub. No.: US 2025/0086002 A1
(43) Pub. Date: Mar. 13, 2025

(54) RECOMMENDATION OF CORRELATED APPLICATIONS TO RESOLVE A SERVICE INCIDENT

(71) Applicant: Capital One Services, LLC, McLean, VA (US)

(72) Inventors: Kana MISHRA, Farmers Branch, TX (US); Ming WATERS, Walkerton, VA (US); Donald GENNETTEN, Henrico, VA (US); Gaurav JAIN, Plano, TX (US); Nour OMAR, Hurst, TX (US)

(73) Assignee: Capital One Services, LLC, McLean, VA (US)

(21) Appl. No.: 18/243,775

(22) Filed: Sep. 8, 2023

(51) Int. Cl. G06F 9/48

(52) U.S. Cl. CPC G06F 9/48

(57) ABSTRACT

Disclosed herein are system, method, and computer program product embodiments for generating a set of correlated applications by a recommendation system to resolve an incident for an application service (AS). The recommendation system can determine an AS-to-AS similarity matrix based on incident data and contextual data, an AS-to-AS affinity matrix based on the incident data and contextual data, and generate a set of correlated applications based on the similarity matrix and the affinity matrix. The set of correlated applications can also be generated based on pairwise application associations, where an application association between a first application and a second application indicates that the first application and the second application can occur together in an incident or to be changed together as indicated by a change record.

### BACKGROUND

An application, also referred to as an application program, application software, or simply an app, is a computer software package that performs a specific function directly for a user or, in some cases, for another application. An application can be a single self-contained program or a group of programs. Exemplary applications can include word processors, database apps, web browsers, deployment tools, image editors, communication apps, or others. Applications are supported by an operating system (OS) and other supporting programs, typically system software operated on a hardware platform including various processors or circuits. In addition, an application can request services from and communicates with other applications via an application programming interface (API). Multiple applications may operate in coordination to provide an application service, or a service to users, such as allowing a user to deposit a check into a bank account, transfer funds from one account to another, or other services. Sometimes, an error or an incident can happen to an application service or an application. However, with increasing complexity of computer systems and the services provided by them, it may be difficult to identify what may be the cause of the error or incident that happened to an application service or an application, what other applications may be impacted, and how to take corrective actions to fix the incident.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIGS. 1A-1C are block diagrams of a computing system for recommendation of correlated applications to resolve an incident, according to some embodiments.

FIGS. 2A-2B illustrate a flowchart and a diagram of an example process for recommendation of correlated applications to resolve an incident, according to some embodiments.

FIGS. 3A-3B illustrate a flowchart and a diagram of an example process for recommendation of correlated applications to resolve an incident, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

A computing system can include multiple computing devices to operate multiple application software, or apps, to perform operations in coordination to provide services to users. For example, a computing system may include a desktop computer or a mobile device coupled with an application server through a communication network, where the application server may be further coupled to a database server. The mobile device may have a client application providing service to a user so that the user can deposit a check into a bank account managed by the application server and the database server, or transfer funds from one account to another managed by the application server. In general, multiple application software, or simply apps, can operate on the multiple computing devices in coordination to provide the services.

Sometimes, an error or an incident may happen with the service provided by multiple application software operated on the multiple devices. For example, a user may fail to transfer a fund from one bank account to another. When an incident happens, often there can be multiple apps malfunctioning instead of a single app causing the incident. However, with increasing complexity of computer systems and the services provided by them, it may be difficult to identify what may be the cause of the error or incident, what other applications may be impacted, and how to take corrective actions to fix the incident.

In the current industry practice, when an incident happened to a service provided to a user, such as when a user fails to transfer fund from one bank account to another account, there can be a very lengthy process to go through in order to find the impacted applications and to perform corrective operations to provide the service again. When troubleshooting an incident to determine which applications may be involved in the incident, technical support agents frequently dig through mountains of logs, dashboards, and alerts, and may exhaustively search for the potentially impacted applications. Such a lengthy process in resolving the incident can result in delays to bring the service back to the user, causing frustration and potential damages to the user. The technical support agents may rely on experiences accumulated over months or years working to support incident resolution. However, such experience can be lost when the technical support agents are transferred to a new job position or are otherwise not available for the next incident. With an ever evolving technology ecosystem, a quicker and more effective solution for identifying the root cause of the incident, and further identifying the impacted applications or correlated applications to resolve the incident is desired.

Embodiments herein provide a recommendation system that uses machine learning to learn correlations between applications based on historical and real time contextual data of incidents, which can identify applications that may be the potential causes of an incident. Instead of solving the complete problem of resolving the incident in one step, the recommendation system herein can identify the impacted or correlated applications giving a potential root cause application to the incident. In other words, embodiments herein can identify a set of correlated applications for a specific application, where the specific application may be a known root cause application to the incident or an assumed root cause application. In some embodiments, the set of correlated applications and the specific application (e.g., the application that was the root cause of the incident) may be identified by a set of identifier(s) for the set of correlated applications and a root identifier to identify a root cause application.

In some embodiments, the recommendation system can use machine learning to learn correlations between applications based on a historical incident-application relation database and real time contextual data, and recommend the set of correlated applications for a specific application. In some embodiments, the historical incident-application relation database shows the relationship between a historical incident and a group of applications, which can keep a record of resolutions to same or similar incidents that happened before. Such a historical incident-application relation database can be implemented by a relational database or any other database technology, and can provide a starting point for the recommendation system. For example, when an incident related to a customer's money transfer failure is resolved, the recommendation system may keep a record of what applications are impacted, and may recommend the same or similar applications the next time a customer's money transfer fails again.

In addition, the recommendation system can further consider real time contextual data including alerts from infrastructure, change records including multiple applications that are changed concurrently, application programming interface (API) call sequence of applications, traffic between network communications for applications, or other data in connection with multiple applications. By considering the detailed real time contextual data, the recommendation system can provide more relevant and correlated applications for a root cause or a potential root cause to resolve the incident. With machine learning and the ever improving database, the recommendation system can become smarter over time.

In comparison, other machine learning based mechanisms may only consider the historical incident-application relation database, or a generic real time data, but without considering the detailed real time contextual data including alerts from infrastructure, change records including multiple applications that are changed concurrently, API call sequence of applications, traffic between network communications for applications. As a result, only partial interactions between application services can be discovered by other machine learning based mechanisms. Embodiments herein leverages the different strengths of the relationship between the services and the datasets. Accordingly, in comparison with other machine learning solutions, embodiments herein can improve the functionality of a computer or a machine learning system by learning a better representation of associations between applications in addition to more relevant datasets, such as the detailed real time contextual data.

Based on the detailed real time contextual data in addition to the historical incident-application relation database, embodiments herein can generate a set of correlated applications for a specific application by the recommendation system to resolve a service incident. In some embodiments, the specific application may be a root cause of an incident for providing a service, and the set of correlated applications may be the set of applications impacted by the root cause, which may be referred to as the correlated applications of the specific application. In some embodiments, the set of correlated applications for the specific application may be generated based on a similarity matrix or an affinity matrix between a first set of applications and a second set of applications. In some embodiments, the set of correlated applications for the specific application may be generated based on pairwise application associations, where an application association between a first application and a second application indicates that the first application and the second application can occur together in an incident or to be changed together as indicated by a change record.

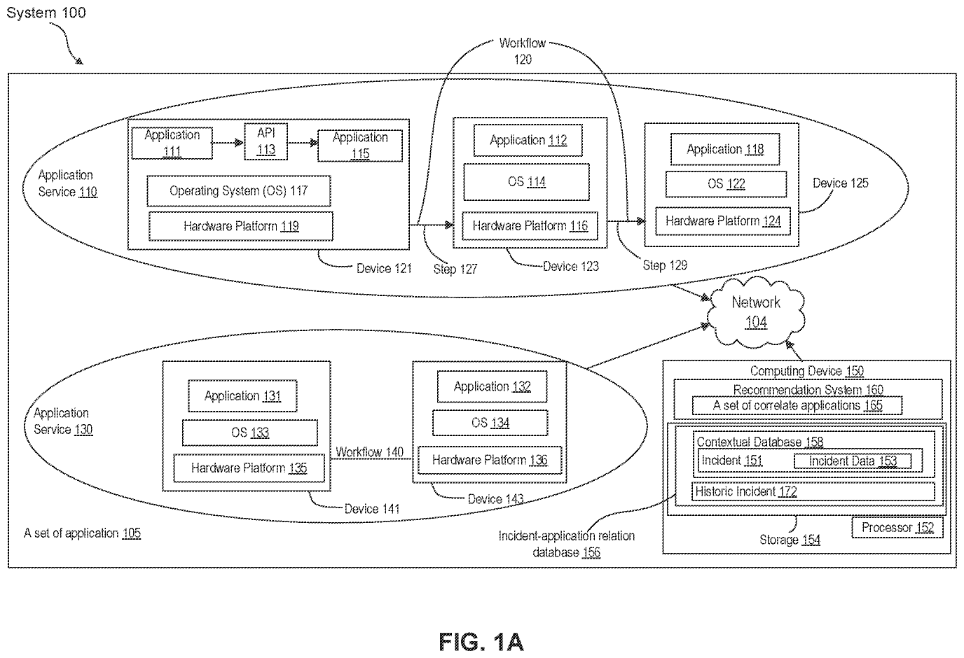

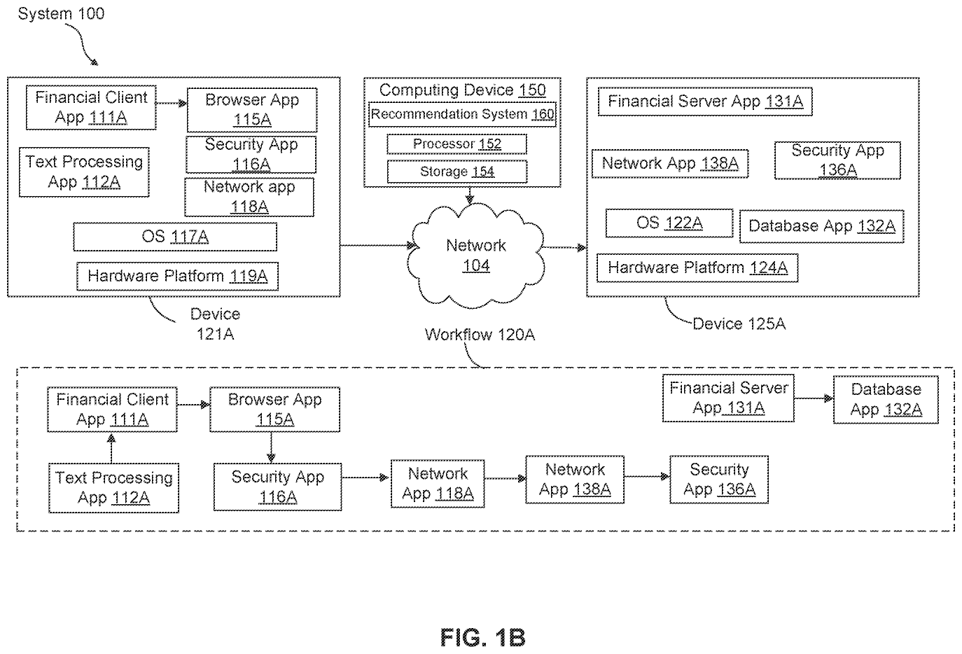

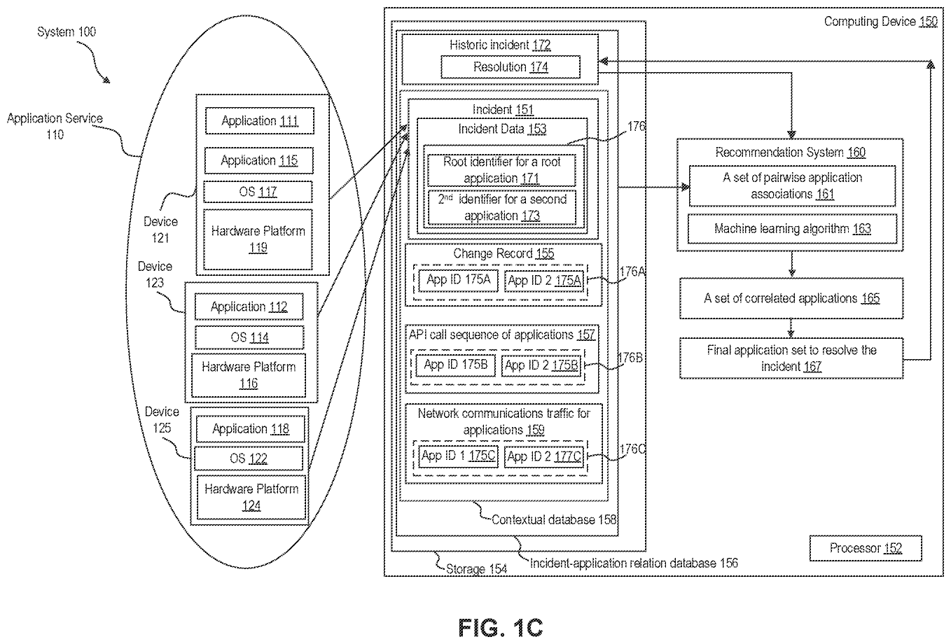

FIGS. 1A-1C are block diagrams of a computing system 100 for identifying correlated applications to resolve an incident, according to some embodiments. Computing system 100 can include multiple devices or computing devices, such as a device 121, a device 123, a device 125, a device 141, and a device 143 coupled together to a computing device 150 through a network 104. A recommendation system 160 can be operated by computing device 150.

Multiple applications can operate on the devices. For example, an application 111 and an application 115 can operate on device 121 with a hardware platform 119 and an operating system (OS) 117; an application 112 can operate on device 123 with a hardware platform 116 and an operating system 114; an application 118 can operate on device 125 with a hardware platform 124 and an operating system 122; an application 131 can operate on device 141 with a hardware platform 135 and an operating system 133; and an application 132 can operate on device 143 with a hardware platform 136 and an operating system 134.

Multiple applications can provide a service to a user. For example, application 111, application 115, application 112, and application 118 can operate in coordination to provide an application service (AS) 110, which can be simply referred to as a service. Accordingly, application service 110 includes application 111, application 115, application 112, and application 118. Similarly, application 131 and application 132 can operate in coordination to provide an application service 130. In some embodiments, the applications for application service 110 may be referred to as a first set of applications, and all the applications operated by all devices of computing system 100, which include application 111, application 115, application 112, application 118, application 131 and application 132, may be referred to as a second set of applications 105, where the first set of applications can be a subset of the second set of applications 105. The first set of applications of the AS 110 can form a workflow 120 to provide a service for AS 110, where workflow 120 can include multiple steps, such as step 127 between device 121 and device 123, and a step 129 between device 123 and device 125. Workflow 120 of AS 110 provides a service to users following the steps. Workflow 120 can also include steps with a single device, such as an API call 113 between application 111 and application 115. Similarly, applications of AS 130 can form a workflow 140.

In some examples, a device, such as device 121, device 123, device 125, device 141, device 143 can be a wireless communication device, a smart phone, a laptop, a desktop computer, a tablet, a personal assistant, a monitor, a wearable device, an Internet of Thing (IoT) device, a mobile station, a subscriber station, a remote terminal, a wireless terminal, or a user device. In some embodiments, the device can be configured to operate based on a wide variety of wireless communication techniques. These techniques can include, but are not limited to, techniques based on 3rd Generation Partnership Project (3GPP) standards. In some other examples, the device can be a desktop workstation, a server, and/or embedded system, a computing device communicatively coupled to computing device 150 by wired lines. In some embodiments, the device can each include an operating system operated on a hardware platform, where the hardware platform may include one or more processor, controller, digital signal processor, network processor, security processor, an application specific integrated circuit (ASIC), or any other hardware components used in the industry.

In some examples, computing device 150 can include a server device (e.g., a host server, a web server, an application server, etc.), a data center device, or a similar device. Computing device 150 can include one or more processors 152, memory or storage device 154, and recommendation system 160 operated by one or more processors 152. Computing device 150 can further include other components, such as a display device, a network device, not shown. In some embodiments, storage 154 may store an incident-application relation database 156 that includes a contextual database 158 and a historical incident-application relation database storing a historic incident 172. Contextual database 158 can store incident data 153 related to an incident 151 associated with AS 110. Based on incident-application relation database 156 including contextual database 158, recommendation system 160 can generate a set of correlated applications 165, which are correlated with a specific application such as a root cause application of incident 151. Details of operations of recommendation system 160 are shown in FIGS. 1B-1C, FIGS. 2A-2B, and 3A-3B below.

In some embodiments, device 121, device 123, device 125, device 141, and device 143 are coupled together to computing device 150 through network 104. Network 104 can include an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks. In some embodiments, network 104 can include a cloud computing system that delivers computing as a service or shared resources. Cloud computing systems can provide computation, software, data access, storage, and/or other services that do not require end-user knowledge of a physical location and configuration of a system and/or a device that delivers the services. Examples of cloud computing systems can include Amazon® Web Services (AWS), Microsoft® Azure, Google® Cloud, IBM® Cloud, Oracle® Cloud Infrastructure, or any other cloud computing system.

FIG. 1B further illustrates some additional details of computing system 100, which can be the same computing system 100 shown in FIG. 1A for identifying correlated applications to resolve an incident, according to some embodiments. Computing system 100 can include multiple devices or computing devices, such as a device 121A and a device 125A coupled to a computing device 150 by network 104. Recommendation system 160 can be operated by computing device 150. Device 121A and device 125A can be an example of device 121 and device 125 as shown in FIG. 1A, respectively.

In some embodiments, multiple applications can operate on the devices. For example, a financial client application 111A, a browser application 115A, a text processing application 112A, a security application 116A, and a network application 118A can operate on device 121A with a hardware platform 119A and an operating system 117A. Similarly, a financial server application 131A, a security application 136A, a network application 138A, and a database application 132A can operate on device 125A with a hardware platform 124A and an operating system 122A. Applications shown in FIG. 1B are examples of applications shown in FIG. 1A, such as application 111.

In some embodiments, various applications shown in FIG. 1B can work together to form a workflow 120A to provide a financial service to a user, where the financial functions can be performed by financial client application 111A operated by device 121A and financial server application 131A operated by device 125A. Device 121A may function as a client device and device 125A may function as a server device to provide the service to device 121A.

In some embodiments, workflow 120A can illustrate the steps involving the various applications operated by device 121A and device 125A. For example, a remote deposit service can include an application that obtains data from a user and an application that takes an image of a check for deposit. These two applications work in concert to provide a workflow for depositing a check. User input can be received and processed by text processing application 112A, which can provide input to financial client application 111A. Financial client application 111A can be operated within a browser application 115A such as a Chrome® web browser. In response to user input received from text processing application 112A, financial client application 111A can further call security application 116 to provide security operations, such as encryption, for data generated by financial client application 111A, further call network application 118A to transmit the secured data or encrypted data to applications on device 125A.

In some embodiments, network application 138A on device 125A can receive the secured data from device 121A, and call security application 136A to perform related security operations to determine the data generated by financial client application 111A, such as performing decryption on the encrypted data from device 121A. The decrypted data can be provided to financial server application 131A. In response to the data generated by financial client application 111A, financial client application 131A can call database application 132A to perform any database operations, such as update a user bank account in response to a deposit operation performed by the user, or read an account balance in response to a user account inquiry.

In some embodiments, the operations shown in workflow 120A follow a linear order among all the steps of operations, where one operation can be performed before or after another operation. In some embodiments, workflow 120A can form a graph where operations can form a partial order. The linear order or a partial order among the operations performed by the various applications can provide a contextual data indication of application associations or application correlations. For example, if an error is detected at operations performed by financial client application 111A, all other operations following financial client application 111A may also have errors. A root cause application among a set of applications may be an application that has the smallest order among the set of applications, which can mean that the root cause application performs operations ahead of the other applications of the set of applications. When a first application performs operations before a second application performing operations, the operation results of the first application may impact the operations of the second application. Accordingly, the first application may impact the second application.

FIG. 1C further illustrates details of recommendation system 160 operated by computing device 150 in connection with an incident, such as incident 151 related to AS 110, where AS 110 includes application 111, application 115, application 112, and application 118. Computing device 150 includes storage 154, processor 152, and recommendation system 160 operated by processor 152.

In some embodiments, storage 154 can store incident data 153 related to incident 151 associated with AS 110 including a first set of applications, such as application 111, application 115, application 112, and application 118. As shown in FIG. 1A, application 111, application 115, application 112, and application 118 are a subset of applications of the second set of applications 105. The second set of applications 105 may support a plurality of application services including application service 110 and application service 130. The second set of applications 105 may include all the applications operated by all devices of computing system 100 so that recommendation system 160 identifies the potentially impacted applications by an incident such as incident 151 among the second set of applications 105. In some embodiments, the second set of applications 105 can include more applications than the first set of applications included in AS 110.

In some embodiments, incident data 153 can include a root identifier to identify a root cause application 171 of workflow 120 that causes other applications of the workflow, such as a second identifier for a second application 173, to generate incident 151. Root cause application 171 and the second application 173 can form an application association 176. In some embodiments, incident data 153 is included in contextual database 158, which is a part of incident-application relation database 156. Contextual database 158 can further include a change record 155 to indicate that a plurality of applications are changed together within computing system 100, an API call sequence of applications 157, a network communications traffic for applications 159, etc., In addition to contextual database 158, incident-application relation database 156 can further include a historic incident 172 and information about the resolution 174 to historic incident 172. Information about the resolution 174 can include a list of applications that have been impacted or cause by historic incident 172, what operations have been performed to the list of applications to resolve historic incident 172, system configuration information for historic incident 172, and many other information known to one having ordinary skills in the art.

In some embodiments, change record 155, API call sequence of applications 157, and network communications traffic for applications 159 can include a plurality of pairwise application associations including an application association between two applications. For example, change record 155 can include an application association 176A, which indicates an association between application 175A represented by an application identifier and application 177A represented by another application identifier. In some embodiments, application association 176A indicates that application 175A and application 177A have been changed at about a same time. For example, application 175A and application 177A both have installed a new version, and the new version may have caused incident 151. Similarly, application 175A and application 177A both have changed part of the program code, installed a program patch to enhance the functionality of the applications, or to remove known software bugs. Such a record may be kept in a maintenance log for computing system 100. API call sequence of applications 157 can include an application association 176B, which indicates an association between application 175B represented by an application identifier and application 177B represented by another application identifier. In some embodiments, application association 176B indicates that application 175B may call an API provided by application 177B, or there is a communication of data between application 175B and application 177B. Such a record may be created when application 175B and application 177B are designed, which can be shown in their respective programs and code. Network communications traffic for applications 159 can include an application association 176C, which indicates an association between application 175C represented by an application identifier and application 177C represented by another application identifier. Such a record may be created when application 175C and application 177C are designed or obtained by monitoring the operations of application 175C and application 177C. In some embodiments, application association 176C indicates that there is network traffic sent from application 175C to application 177C. Applications shown in contextual database 158, such as application 175A, application 177A, application 175B, application 177B, application 175C, application 177C, are selected from the second set of applications 105.

In some embodiments, recommendation system 160 may be a machine learning system that helps to discover a set of correlated applications 165. Accordingly, recommendation system 160 can be implemented by various recommendation system techniques such as collaborative filtering algorithms, collaborative filtering algorithms, content filtering Context filtering algorithms, or any other algorithms known to one having ordinary skills in the arts. In addition, recommendation system 160 can be implemented by artificial neural networks (ANNs), convolutional neural networks, recurrent neural networks, or any other neural network models known to one having ordinary skills in the arts. In some embodiments, recommendation system 160 can perform operations to identify a set of pairwise application associations 161 including an application association between two applications, such as the application association 176 between application 171 and application 173 indicating a co-occurrence of the two applications in a same incident data 153, application association 176A indicating co-occurrence of the two applications in a same change record 155, application association 176B indicating co-occurrence of the two applications in a same API call sequence of applications 157, and application association 176C indicating co-occurrence of the two applications in a same network communications traffic for applications 159.

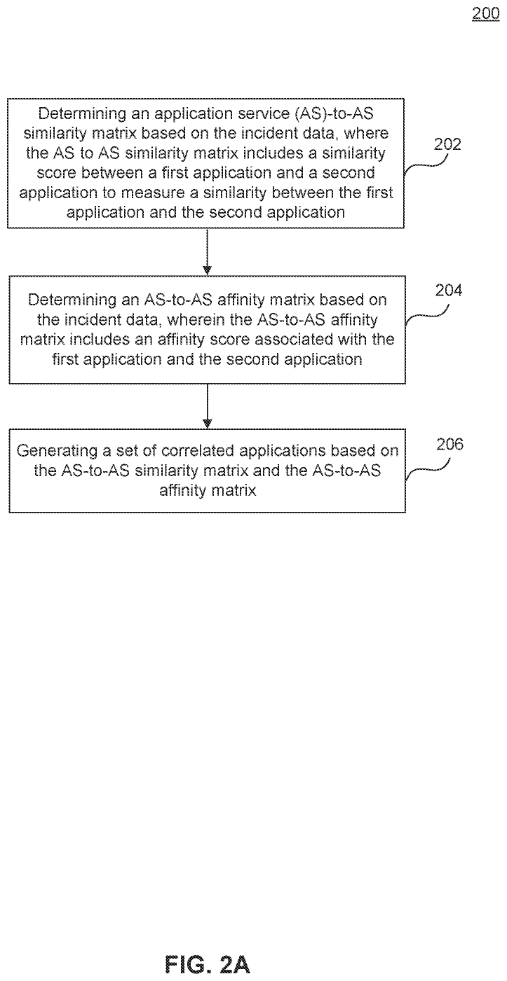

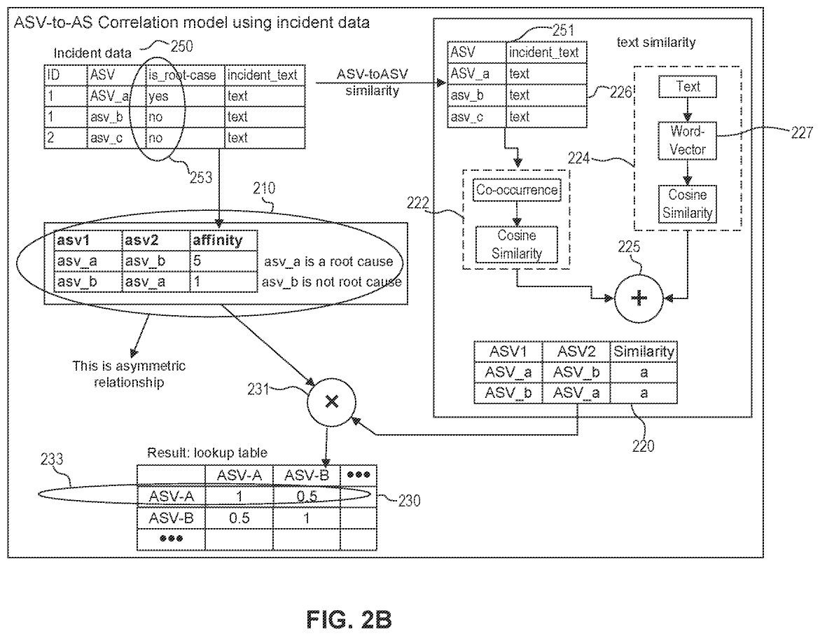

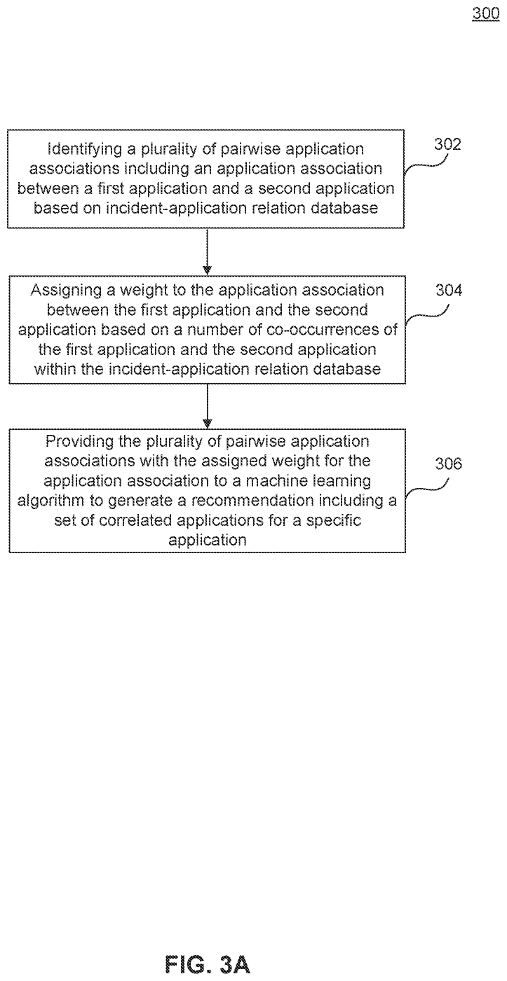

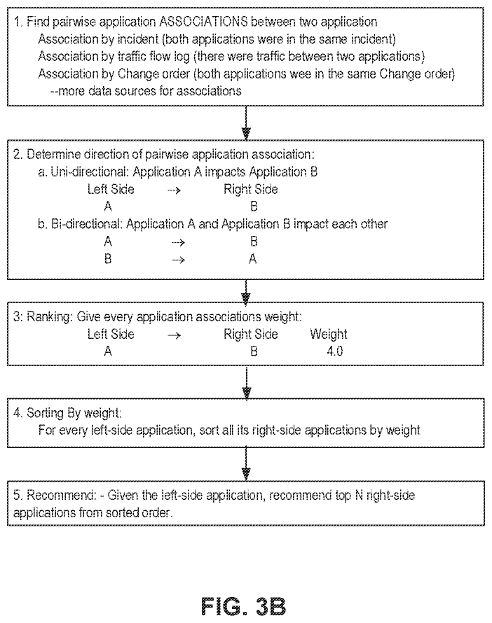

In some embodiments, based on the set of pairwise application associations 161 and machine learning algorithms at 163, recommendation system 160 can generate a set of correlated applications 165, which may be correlated to a specific application such as the root application 171. In some embodiments, the set of correlated applications 165 can be generated based on AS-to-AS similarity matrix and AS-to-AS affinity matrix as illustrated in process 200 shown in FIG. 2A. In some embodiments, the set of correlated applications 165 can be generated based on weight assignments to the application association as illustrated in process 300 shown in FIG. 3A.

In some embodiments, based on the set of correlated applications 165, a final application set 167 to resolve incident 151 can be determined. In some embodiments, final application set 167 to resolve incident 151 is determined by recommendation system 160. The final application set to resolve the incident can be saved into incident-application relation database 156 to be used to resolve future incidents.

FIGS. 2A-2B illustrate a flowchart and a diagram of an example process 200 for recommendation of correlated applications 165 to resolve incident 151, according to some embodiments. Process 200 can be performed by recommendation system 160 operated by processor 152 of computing device 150.

In 202, recommendation system 160 can determine an AS-to-AS similarity matrix based on incident data 153. The AS-to-AS similarity matrix can include a similarity score between a first application and a second application to measure a similarity between the first application and the second application.

In some embodiments, as shown in FIG. 2B, the incident data are shown in table 250, which can be an example of incident data 153. Table 250 includes multiple rows and columns showing 3 applications with identifier 1, 2, and 3, and names “asv_a,” “asv_b,” and “asv_c,” respectively. In some embodiments, “asv_a,” “asv_b,” and “asv_c,” can represent part of application 111, application 115, application 112, and application 118 of AS 110. In another embodiment, “asv_a,” “asv_b,” and “asv_c” represents the entire application. The column 253, “is_root_case”, indicates whether the application is a root cause application. As shown, application 1 has “yes” indicating application 1 is a root cause application, while application 2 and application 3 are not root cause applications. The “yes” in table 250 is an example of a root identifier to identify a root cause application of workflow 120 that causes other applications of the workflow to generate incident 151. The determination of an application to be a root cause application, such as application “asv_a” in Table 250 is performed by computing system 100 based on some monitoring function, some preliminary analysis, or any other ways known to one having ordinary skills of the art. In some embodiments, a root cause application may be assumed based on experience, which is assumed for performing the analysis of the corrected applications. Furthermore, table 250 includes a text description for each application of the first set of applications of AS 110.

In some embodiments, as shown in FIG. 2B, recommendation system 160 can determine an AS-to-AS similarity matrix 220 based on table 250 representing incident data 153. As shown in similarity matrix 220, application “asv_a” and application “asv_b” can have a similarity score “a” to measure a similarity between application “asv_a” and application “asv_b” of AS 110. In some embodiments, the score “a” can be a numeral value between 0 and 1. The similarity between application “asv_a” and application “asv_b” refers to the likelihood of application “asv_a” and application “asv_b” occurring together in records stored in incident-application relation database 156 or contextual database 158. In some embodiments, recommendation system 160 can determine the similarity score “a” between application “asv_a” and application “asv_b” of AS 110 based on incident-application relation database 156 and machine learning algorithms at 163 as shown in FIG. 1C.

In some embodiments, similarity between two applications can be measured using a distance metric. Nearest points are the most similar and farthest points are the least relevant. The similarity is subjective and is highly dependent on the domain and application. Various distances, such as Minkowski distance, Manhattan distance, Hamming distance, Euclidean Distance, Cosine similarity, or other similarity measurements known to one having the ordinary skills in the art can be used.

In some embodiments, recommendation system 160 can first generate a simplified table 251 representing table 250, where some information, such as the identifier and the root-case indicator, are removed from table 250. Afterwards, recommendation system 160 can generate the AS-to-AS similarity matrix 220 based on cosine similarity 222 of co-occurrence of application “asv_a” and application “asv_b” based on incident-application relation database 156 generated based on resolutions to historic incidents, such as historic incident 172 and its resolution 174, contextual database 158, and associated with the plurality of application services operated by the computing system, such as AS 110 and AS 130.

In some embodiments, recommendation system 160 can generate AS-to-AS similarity matrix 220 based on cosine similarity 224 of word vectors 227 based on the text description 226 for each application of the first set of applications of the incident data as shown in table 251, such as application “asv_a”, application “asv_b”, and application “asv_c.” Word vectors 227 can be generated for text description 226 based on some word embedding techniques known to one having the ordinary skills in the art. The two cosine similarities, cosine similarity 224 and cosine similarity 222 can be added up component by component at 225 to generate AS-to-AS similarity matrix 220.

In 204, recommendation system 160 can determine an AS-to-AS affinity matrix based on the incident data. AS-to-AS affinity matrix can include an affinity score associated with the first application and the second application.

In some embodiments, as shown in FIG. 2B, AS-to-AS affinity matrix 210 can include an affinity score 5 associated with application “asv_a” and application “asv_b”. In some embodiments, the affinity score “5” associated with application “asv_a” and application “asv_b” measures a causality between application “asv_a” and application “asv_b”. AS-to-AS affinity matrix 210 can be an asymmetric matrix. For example, AS-to-AS affinity matrix 210 can have an affinity score 1 associated with application “asv_b” and application “asv_a.” Accordingly, the affinity score “5” associated with application “asv_a” and application “asv_b” means the likelihood of an error of application “asv_a” causing an error of application “asv_b” is ranked at 5, which is larger than the likelihood (ranked at 1) of an error of application “asv_b” causing an error of application “asv_a”. In some embodiments, recommendation system 160 can determine the affinity score “5” or the affinity score “1” based on incident-application relation database 156 and machine learning algorithms at 163 as shown in FIG. 1C.

In 206, recommendation system 160 can generate a set of correlated applications based on the similarity matrix and the affinity matrix. In some embodiments, the recommendation system can be configured to generate a recommendation table based on the similarity matrix and the affinity matrix. A row of the recommendation table can include the first application and the set of correlated applications for the first application. In some embodiments, to generate the row of the recommendation table, the recommendation system can multiply a row of the AS-to-AS affinity matrix with the AS-to-AS similarity matrix.

In some embodiments, as shown in FIG. 2B, recommendation system 160 can generate a set of correlated applications 233 for application “asv_a” based on similarity matrix 220 and affinity matrix 210. In some embodiments, recommendation system 160 can generate a recommendation table 230 based on similarity matrix 220 and affinity matrix 210. A row of recommendation table 230 can include application “asv_a” and the set of correlated applications for “asv_a”. In some embodiments, to generate row 233 of recommendation table, recommendation system 160 can perform multiplication operation 231 to multiply a row of the AS-to-AS affinity matrix 210 with the AS-to-AS similarity matrix 220.

FIGS. 3A-3B illustrate a flowchart and a diagram of an example process 300 for recommendation of correlated applications 165 to resolve incident 151, according to some embodiments. Process 300 can be performed by recommendation system 160 operated by processor 152 of computing device 150.

In 302, recommendation system 160 can identify a plurality of pairwise application associations, which can include an application association between a first application and a second application. The application association between the first application and the second application exists when there is a co-occurrence of the first application and the second application occurring in a same incident data, or occurring in a same change record of a contextual database, or associated in some other ways.

In some embodiments, as shown in FIG. 1C, contextual database 158 can include incident data 153, change record 155, API call sequence of applications 157, and network communications traffic for applications 159. There can be application association 176, 176A, 176B, and 176C included in incident data 153, change record 155, API call sequence of applications 157, and network communications traffic for applications 159, respectively. Application association 176, 176A, 176B, and 176C are examples of the plurality of pairwise application associations identified by recommendation system 160.

In some embodiments, as shown in FIG. 3C, recommendation system 160 can find pairwise application associations, which can include association by incident (both applications were in the same incident data, such as application association 176), Association by traffic flow log (there were traffic between two applications, such as application association 176C included in network communications traffic for applications 159), Association by Change order (both applications were in the same change order, such as application association 176A included in change record 155), and more data sources for associations such as application association 176B included in API call sequence of applications 157.

In some embodiments, as shown in FIG. 3C, recommendation system 160 can determine a direction of an application association. In some embodiment, an application association can be unidirectional, where there is one direction from Application A to Application B showing Application A can impact Application B. Such a unidirectional application association can be denoted as following, where Application A is placed at the left side of the label “→”, and Application B is placed at the right side of the label “→”:

| Left Side | Right Side |
|---|---|
| A | → B |

In some embodiments, an application association can be bidirectional, where Application A can impact Application B, and vice versa. Such a bidirectional application association can be denoted as following:

| Left Side | Right Side |
|---|---|
| A | → B |
| B | → A |

In 304, recommendation system 160 can assign a weight to an application association between the first application and the second application based on a number of co-occurrences of the first application and the second application. The number of co-occurrences of the first application and the second application can be determined based on contextual database 158 and incident-application relation database 156, which include all of the co-occurrences of the first application and the second application for all application services provided by computing system 100.

In some embodiments, as shown in FIG. 3C, recommendation system 160 can assign a weight to an application association as follows:

| Left Side | Right Side | Weight |
|---|---|---|
| A | → B | 4.0 |

In some embodiments, as shown in FIG. 3C, recommendation system 160 can further sort all the application associations based on the weight assigned to each application association. For every application appearing in the left-side of the application association, recommendation system 160 can sort all its right-side applications by weight.

In 306, recommendation system 160 can provide the plurality of application associations with the assigned weight for the application association to a machine learning algorithm to generate a recommendation including a set of correlated applications for a specific application.

In some embodiments, as shown in FIG. 3C, for a specific application appearing in the left-side of an application association, recommendation system 160 can recommend top N right-side applications based on the sorted order of weights assigned to application associations. The recommended top N right-side applications can form the set of correlated applications for the specific application.

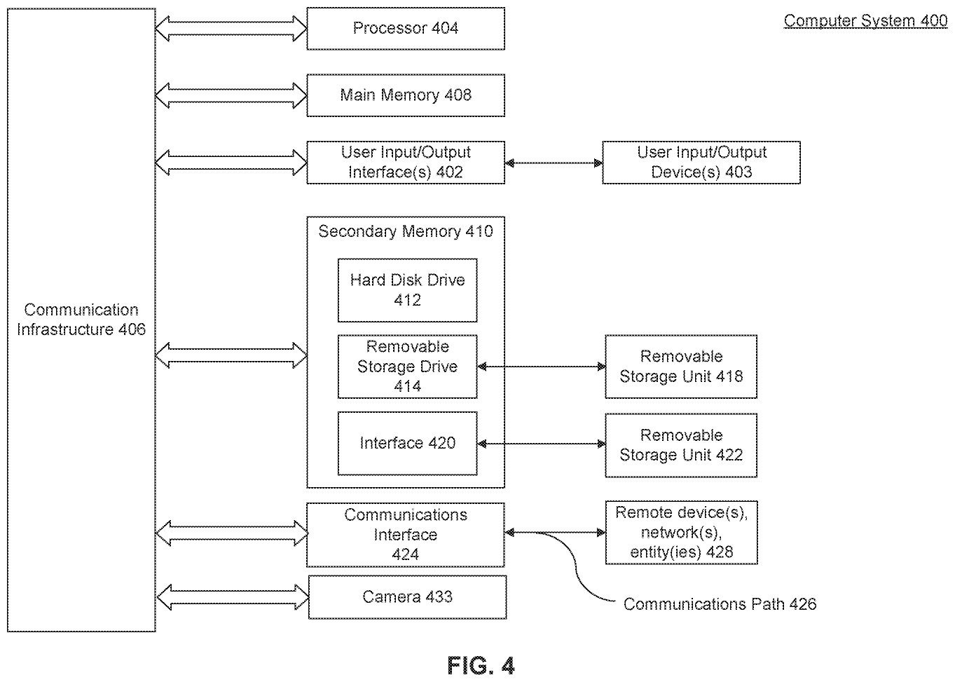

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406. Computer system 400 may be examples of device 121, device 123, device 125, device 141, device 143, computing device 150, device 121A, device 125A, as shown in FIGS. 1A-1C, to perform process 200 or process 300 as shown in FIGS. 2A and 3A.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426. Computer system 400 may further include a camera 433.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein. For example, control logic may cause processor 404 to determine an AS-to-AS similarity matrix based on the incident data, wherein the AS-to-AS similarity matrix includes a similarity score between a first application and a second application to measure a similarity between the first application and the second application selected from the first set of applications; determine an AS-to-AS affinity matrix based on the incident data, wherein the AS-to-AS affinity matrix includes an affinity score associated with the first application and the second application; and generate a set of correlated applications for the first application based on the similarity matrix and the affinity matrix, as shown in FIG. 2A for process 200. In addition, control logic may cause processor 404 to identify a plurality of pairwise application associations, which can include an application association between a first application and a second application; assign a weight to an application association between the first application and the second application based on a number of co-occurrences of the first application and the second application; and provide the plurality of application associations with the assigned weight for the application association to a machine learning algorithm to generate a recommendation including a set of correlated applications for a specific application, as shown in FIG. 3A for process 300.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A computing device to operate a recommendation system, comprising:
storage configured to store incident data and contextual data related to an incident associate with an application service (AS) including a subset of applications selected from a set of applications, wherein the set of applications support a plurality of application services including the AS operating within a computing system including the computing device, and the subset of applications of the AS form a workflow to provide a service for the AS, wherein the incident data includes at least a root identifier to identify a root cause application of the workflow that causes other applications of the workflow to generate the incident; and
the recommendation system operated by one or more processors coupled to the storage and configured to:
determine an AS-to-AS similarity matrix based on the incident data and the contextual data, wherein the AS-to-AS similarity matrix includes a similarity score between a first application and a second application to measure a similarity between the first application and the second application selected from the subset of applications;
determine an AS-to-AS affinity matrix based on the incident data and the contextual data, wherein the AS-to-AS affinity matrix includes an affinity score associated with the first application and the second application; and
generate a set of correlated applications for the first application based on the similarity matrix and the affinity matrix.

2. The computing device of claim 1, wherein the affinity score associated with the first application and the second application measures a causality between the first application and the second application.

3. The computing device of claim 1, wherein the AS-to-AS affinity matrix is an asymmetric matrix.

4. The computing device of claim 1, wherein the application service is provided by one or more devices including a device coupled to the one or more processors of the computing device via a network.

5. The computing device of claim 1, wherein the recommendation system is further configured to generate the AS-to-AS similarity matrix based on cosine similarity of co-occurrence of the first application and the second application based on an incident-application relation database generated based on resolutions to historic incidents associated with the set of application services operated by the computing system.

6. The computing device of claim 1, wherein the incident data further includes a text description for each application of the subset of applications.

7. The computing device of claim 6, wherein the recommendation system is further configured to generate the AS-to-AS similarity matrix based on cosine similarity of word vectors based on the text description for each application of the subset of applications of the incident data.

8. The computing device of claim 1, wherein the recommendation system is further configured to generate a recommendation table based on the similarity matrix and the affinity matrix, wherein a row of the recommendation table includes the first application and the set of correlated applications for the first application.

9. The computing device of claim 8, wherein to generate the row of the recommendation table, the recommendation system is configured to multiply a row of the AS-to-AS affinity matrix with the AS-to-AS similarity matrix.

10. The computing device of claim 8, wherein the incident data and the contextual data are included in an incident-application relation database, and the contextual data further includes a change record to indicate that a plurality of applications are changed together within the computing system, and to generate the recommendation table, the recommendation system is further configured to:
identify a plurality of pairwise application associations including an application association between a third application and a fourth application based on the incident-application relation database, wherein the application association between the third application and the fourth application exists when there is a co-occurrence of the third application and the fourth application occurring in a same incident data, or occurring in the same change record; and
generate the recommendation table based on the plurality of pairwise application associations.

11. A method performed by a recommendation system, comprising:
determining an application service (AS) to AS similarity matrix based on incident data and contextual data related to an incident associate with an AS including a subset of applications selected from a set of applications, wherein the set of applications support a plurality of application services including the AS operating within a computing system including the computing device, and the subset of applications of the AS form a workflow to provide a service for the AS, wherein the incident data includes at least a root identifier to identify a root cause application of the workflow that causes other applications of the workflow to generate the incident, and the AS-to-AS similarity matrix includes a similarity score between a first application and a second application to measure a similarity between the first application and the second application selected from the subset of applications;
determining an AS-to-AS affinity matrix based on the incident data and the contextual data, wherein the AS-to-AS affinity matrix includes an affinity score associated with the first application and the second application; and
generating a recommendation table based on the similarity matrix and the affinity matrix, wherein a row of the recommendation table includes the first application and a set of correlated applications for the first application.

12. The method of claim 10, wherein the affinity score associated with the first application and the second application measures a causality between the first application and the second application.

13. The method of claim 10, wherein the application service is provided by one or more devices including a device coupled to the one or more processors via a network.

14. The method of claim 10, further comprising:
generating the AS-to-AS similarity matrix based on cosine similarity of co-occurrence of the first application and the second application based on an incident-application relation database generated based on resolutions to historic incidents associated with the plurality of application services.

15. The method of claim 10, wherein the incident data further includes a text description for each application of the subset of applications.

16. The method of claim 15, further comprising:
generating the AS-to-AS similarity matrix based on cosine similarity of word vectors based on the text description for each application of the subset of applications of the incident data.

17. The method of claim 10, wherein the generating the row of the recommendation table comprises multiplying a row of the AS-to-AS affinity matrix with the AS-to-AS similarity matrix.

18. A non-transitory computer readable medium including instructions for causing a processor to perform operations comprising:
determine an application service (AS) to AS similarity matrix based on incident data and contextual data related to an incident associate with an AS a subset of applications selected from a set of applications, wherein the set of applications support a plurality of application services including the AS operating within a computing system including the computing device, and the subset of applications of the AS form a workflow to provide a service for the AS, wherein the incident data includes at least a root identifier to identify a root cause application of the workflow that causes other applications of the workflow to generate the incident, and the AS-to-AS similarity matrix includes a similarity score between a first application and a second application to measure a similarity between the first application and the second application selected from the subset of applications;
determine an AS-to-AS affinity matrix based on the incident data and the contextual data, wherein the AS-to-AS affinity matrix includes an affinity score associated with the first application and the second application; and
generate a recommendation table based on the similarity matrix and the affinity matrix, wherein a row of the recommendation table includes the first application and a set of correlated applications for the first application.

19. The non-transitory computer readable medium of claim 18, wherein the affinity score associated with the first application and the second application measures a causality between the first application and the second application.

20. The non-transitory computer readable medium of claim 18, wherein the application service is provided by one or more devices including a device coupled to the one or more processors via a network.
